(19) United States
(12) Patent Application Publication
(10) Pub. No.: US 2008/0152961 A1
(43) Pub. Date: Jun. 26, 2008

(54) Purging a fuel cell system

(76) Inventors: Zhi Zhou, Selkirk, NY (US); Zhigang Qi, Albany, NY (US)

Correspondence Address: TROP PRUNER & HU, PC, 1616 S. VOSS ROAD, SUITE 750, HOUSTON, TX, 77057-2631, US

(21) Appl. No.: 11/644,521

(22) Filed: Dec. 22, 2006

(51) Int. Cl. H01M 8/02

(52) U.S. Cl. 429/13; 429/12; 429/26

(57) ABSTRACT

A technique includes communicating fuel and oxidant to a reactor and/or a steam generator and flowing an exhaust from the reactor and/or steam from the steam generator through a fuel cell to purge various types of fuel cells.

### BACKGROUND

The invention generally relates to purging a fuel cell system and more particularly, the invention relates to purging components of the fuel cell system, such as a fuel cell stack and/or oxidizer.

A fuel cell is an electrochemical device that converts chemical energy directly into electrical energy. There are many different types of fuel cells, such as solid oxide, molten carbonate, phosphoric acid, methanol and proton exchange membrane (PEM) fuel cells.

As a more specific example, a PEM fuel cell includes a PEM membrane, which permits only protons to pass between an anode and a cathode of the fuel cell. A typical PEM fuel cell may employ polysulfonic-acid-based ionomers and operate up to 80° Celsius (C.). Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) ionizes to produce protons that pass through the PEM. The electrons produced by this reaction travel through circuitry that is external to the fuel cell to form an electrical current. At the cathode, oxygen is reduced by reacting with the protons and electrons to form water. The anodic and cathodic reactions are described by the following equations:

H₂→2H⁺+2e⁻at the anode of the cell Equation 1

O₂+4H⁺+4e⁻→2H₂O at the cathode of the cell, Equation 2

A typical fuel cell has a terminal voltage near one volt DC. For purposes of producing much larger voltages, several fuel cells (i.e., unit cells) may be assembled together to form an arrangement called a fuel cell stack, an arrangement in which the unit cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one unit cell of the stack. The plates may include various surface flow channels and orifices to, as examples, route the reactants and products through the fuel cell stack. Catalyzed electrically conductive gas diffusion layers (GDLs) may be located on each side of each PEM to form the anode and cathodes of each unit cell. In this manner, reactant gases from each side of the PEM may leave the flow channels and diffuse through the GDLs to reach the PEM.

### SUMMARY

In an embodiment of the invention, a technique includes communicating fuel and oxidant to an oxidizer and flowing an exhaust from the oxidizer through a fuel cell to purge the fuel cell.

In another embodiment of the invention, a technique includes communicating fuel and oxidant to an oxidizer and using the oxidizer to generate a flow to purge a fuel cell in connection with a startup or shutdown of the fuel cell system.

In another embodiment of the invention, a fuel cell system includes a fuel cell, an oxidizer and a control subsystem. The control subsystem communicates an exhaust of the oxidizer through the fuel cell to purge the fuel cell.

In another embodiment of the invention, a fuel cell system includes a fuel cell, an oxidizer and a control subsystem. The control subsystem uses the oxidizer to generate a flow to purge the fuel cell in connection with a startup or shutdown of a fuel cell system.

In yet another embodiment of the invention, steam is produced through evaporation of liquid water in a heat exchanger by the heat generated by the fuel cell system, and the steam is used to purge the stack during either startup or shutdown.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIG. 2 is a flow diagram depicting a technique to purge a fuel cell according to an embodiment of the invention.

FIG. 3 is a flow diagram depicting a technique to startup and to purge a fuel cell system according to an embodiment of the invention.

FIG. 4 is a flow diagram depicting a technique to shut down and purge a fuel cell system according to an embodiment of the invention.

FIG. 5 is a flow diagram depicting a technique to purge a fuel cell by generating stream produced by a component of a fuel cell system according to an embodiment of the invention.

### DETAILED DESCRIPTION

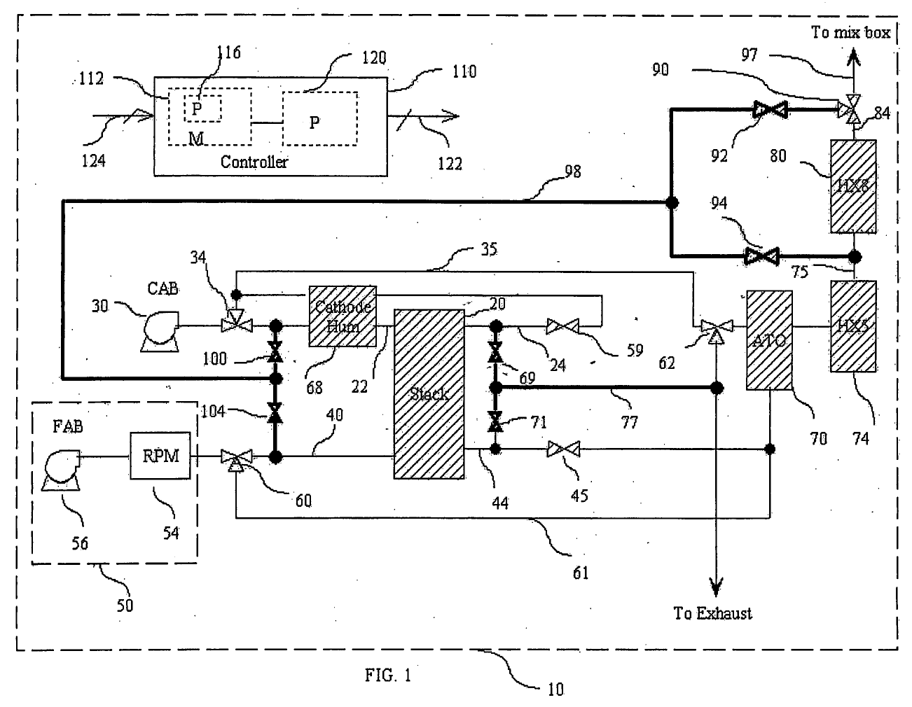

Referring to FIG. 1, in accordance with embodiments of the invention described herein, a fuel cell system 10 includes a fuel cell stack 20, which generates electrical power for a load (not shown) in response to reactant flows (an oxidant flow and a fuel (hydrogen) flow) that are communicated through the stack 20. For purposes of prolonging the life time of the stack 20, the fuel cell system 10 uses inert gas to purge the stack 20 and possibly other components during the shutdown and startup of the system 10.

As a more specific example, the fuel cell system 10 may purge the anode and/or cathode chamber of the fuel cell stack 20 during shutdown and startup. As described herein, the fuel cell system 10 does not use a dedicated reactor or storage tank for purposes of providing the inert purge gas. Instead, the fuel cell system 10 uses a reactor, such as an anode tailgas oxidizer (ATO) 70 (as an example), a component that is already present for normal operation (i.e., outside of the startup and shutdown operations) for purposes of generating the inert gas. In general, the ATO 70 combusts fuel (such as diatomic hydrogen) and an oxidant (such as the oxygen in air). During normal operation, the ATO 70 oxidizes fuel that is not consumed in the electrochemical reactions inside the fuel cell stack; and during purging, the ATO 70 may oxidize fuel that bypasses the fuel cell stack 20 and is provided directly by a fuel source 50.

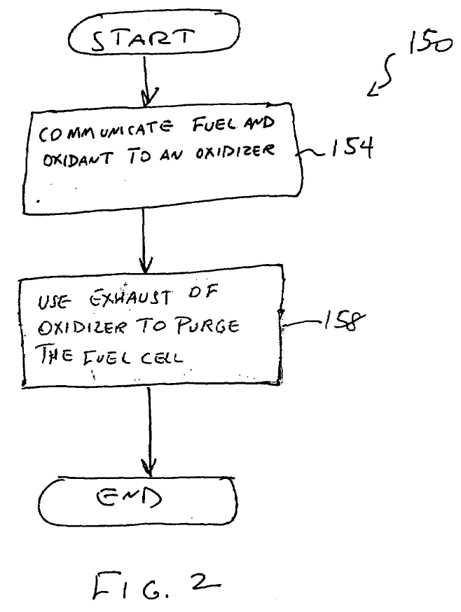

Referring also to FIG. 2, thus, in accordance with embodiments of the invention described herein, a technique 150 to purge a fuel cell includes communicating (block 154) fuel and oxidant to an oxidizer and using (block 158) an exhaust of the oxidizer to purge the fuel cell.

The ATO 70 may directly or indirectly generate the inert gas that is used for purging, depending on the particular embodiment of the invention. More specifically, in accordance with some embodiments of the invention, the exhaust of the ATO 70 may directly supply the inert gas that is used to purge the fuel cell stack 20. The exhaust temperature of the ATO 70 may be too high (550° Celsius (C.), for example) for purging a PEM fuel cell, as a high temperature ATO exhaust, when used for purging, may dry out of the membranes of the fuel cell stack 20. Therefore, the exhaust of the ATO 70 may be communicated through a heat exchanger 74, a heat exchanger in which thermal energy is transferred from the ATO exhaust to another fluid circuit of the fuel cell system 10 to produce a lower temperature (a temperature near or below 100° C., for example) exhaust flow that is more suitable for purging a PEM fuel cell. For example, in accordance with some embodiments of the invention, the heat exchanger 74 may transfer thermal energy from the ATO exhaust to a coolant circuit of the fuel cell system 10. The resultant lowered temperature ATO exhaust appears at an outlet 75 of the heat exchanger 74.

In accordance with some embodiments of the invention, only the exhaust of the heat exchanger 74 is used for purposes of purging the stack 20. However, in accordance with other embodiments of the invention, the exhaust from the heat exchanger 74 is mixed with another flow, such as steam, for purposes of purging the fuel cell stack 20.

In yet another variation, in accordance with some embodiments of the invention, the ATO exhaust is used to form steam which is used solely to purge the fuel cell stack 20. More specifically, the outlet of the heat exchanger 74 may provide an exhaust flow to another heat exchanger 80 of the fuel cell system 10. The heat exchanger 80 generates steam in response to transferring thermal energy from the received ATO exhaust to water to form resultant steam (at an outlet 84 of the heat exchanger 80), which is used to purge the fuel cell stack 20.

Thus, depending on the particular embodiment of the invention, steam may be used solely to purge the fuel cell stack 20, the ATO exhaust may be used solely to purge the fuel cell stack 20 or alternatively, the steam may be mixed with the ATO exhaust and this combined flow may be used to purge the fuel cell stack 20. The mixing of the ATO exhaust from the heat exchanger 74 with steam lowers the ATO exhaust temperature and increases the humidity of the inert gas, which benefits the membranes of the fuel cell stack 20.

In some embodiments of the invention, the heat exchanger 80 may be used for purposes of generating steam to aid reformation that is being performed by a reformer 54 of the fuel source 50. In these embodiments of the invention, only a portion of the steam that is produced by the heat exchanger 80 is available to purge the fuel cell stack 20, as the remaining steam may be furnished to the reformer 54. The advantages, however, in using steam as the inert gas are the steam does not require careful stoichiometry control of the ATO 70 in order to generate the inert gas; steam is readily available from an already-existent heat exchanger 80 during both startup and shutdown of the fuel cell system 10; the risk of steam containing other reactant gases is relatively low; it is safe for the condensate of the steam to be directly communicated through plumbing components, such as float valves, so additional exhaust plumbing may not be needed; and the steam helps incubate the fuel cell stack 20 on startup if the stack 20 has been dormant for a long time or is fresh or new.

During normal operation of the fuel cell system 10 (i.e., after the startup and before the shutdown of the fuel cell system 10), the fuel cell stack 20 receives a fuel flow at its anode inlet 40. As an example, the fuel flow through the fuel cell stack 20 may be provided by the fuel source 50, which may be a hydrogen tank (as an example) or, as depicted in FIG. 1 may include a reformer 54, which converts a hydrocarbon fuel supplied by a fuel blower 56 to a hydrogen rich mixture. It is understood that other types of fuel sources may be used to furnish fuel to the fuel cell stack 20 in accordance with other embodiments of the invention.

The fuel flow that is received at the anode inlet 40 flows through the anode chamber of the fuel cell stack 20 to undergo electrochemical reactions inside the stack 20. This flow results in an anode exhaust that appears at an anode outlet 44 of the fuel cell stack 20 and is routed (depending on the open and closed state of a valve 45) to the ATO 70, which oxidizes residual fuel that is present in the anode exhaust.

The fuel cell stack 20 receives an incoming oxidant flow at a cathode inlet 22. For example, in accordance with some embodiments of the invention, the incoming oxidant flow may be provided by a cathode air blower 30. The incoming oxidant flow is communicated through the cathode chamber of the fuel cell stack 20 to undergo the electrochemical reactions inside the stack 20. The oxidant flow produces a cathode exhaust, which appears at a cathode outlet 24 of the fuel cell stack 20. Depending on the states of a valve 59 and a three-way valve 62, the cathode exhaust may be communicated to the ATO 70 for purposes of combusting the residual fuel from the anode exhaust (i.e., which occurs during normal operation). In accordance with some embodiments of the invention, the oxidant exhaust passes through a cathode humidifier 68 before being communicated to the ATO 70.

Reactant flows can also be arranged by the fuel cell system 10 to bypass the fuel cell stack 20 during purging. More specifically, as depicted in FIG. 1, the inlet of a three-way valve 34 is connected to the outlet of the cathode air blower 30; and the outlets of the valve 34 are connected to an oxidant bypass line 35 and the inlet of a cathode humidifier 68. The outlet of the cathode humidifier 68 is connected to the cathode inlet 22. During normal operation, the three-way valve 34 routes the flow produced by the blower 30 to the inlet 34. Prior to the purging of the fuel cell stack 20, the fuel cell system 10 routes all of the air (using the three-way valve 34) from the cathode air blower 30 bypassing the stack 20 to the oxidant bypass line 35 to the inlet of the three-way valve 62. Similarly, the fuel cell system 10 includes a three-way valve 60 that is connected to the outlet of the reformer 54. During normal operation, the three-way valve 60 communicates the reformate flow to the anode inlet 40 of the fuel cell stack 20. However, prior to the fuel cell stack 20 being purged, the fuel cell system 10 changes the state of the three-way valve 60 to route the reformate through a fuel bypass line 60 to the ATO 70, thereby bypassing the fuel cell stack 20.

The valves 34, 45, 59, 60 and 62 along with other valves of the fuel cell system 10, collectively form part of a controlled subsystem of the fuel cell system 10, which controls the system's reactant flows during startup, shutdown and normal operations. The control subsystem may include additional valves, such as a valve 94 that is coupled between the outlet 75 of the heat exchanger 74 and a purge line 98, which communicates the purge flow. The purge line 98 may be selectively connected via a valve 100 to the inlet of the cathode humidifier 68 or via a valve 104 to the anode inlet 40. Thus, if the fuel cell system 10 purges the fuel cell stack 20 via the ATO exhaust that appears at the outlet 75, the fuel cell system 10 opens the valve 94 to establish communication between the purge line 98 and the outlet 75. Depending on the open/closed states of the valves 100 and 104, the cathode chamber, anode chamber or both the anode and cathode chambers of the fuel cell stack 20 may be purged with the ATO exhaust.

Alternatively, if steam is to be used solely or partially for purposes of purging the fuel cell stack 20, the fuel cell system 10 may open a valve 92. As shown in FIG. 1, the valve 92 is connected to an outlet of a three-way valve 90 and is also connected to the purge communication line 98. The three-way valve 90 is used for purposes of splitting the steam that appears at the outlet 84 of the heat exchanger 80 into a steam flow that is used for purposes of purging the fuel cell stack 20 and a steam flow that is provided to the reformer 54 via another communication line 97. The steam that is allocated for purposes of purging by the valve 90 is communicated to the purge line 98 if the valve 92 is opened. Thus, the fuel cell system 10 may open the valve 92 and close the valve 94 if only the steam is to be used for purposes of purging, and the fuel cell system 10 may open both valves 92 and 94 if a combination of steam and ATO exhaust is to be used for purposes of purging. The fuel cell system 10 may also regulate the cross-sectional flow areas of the valves 90, 92 and 94 for purposes of regulating the steam and ATO exhaust flow rates. Furthermore, as set forth above, the steam mixture may be communicated to one or both of the anode and cathode chambers of the fuel cell stack 20, depending on the states of the valves 100 and 104. Thus, many variations are possible and are within the scope of the appended claims.

Among the other valves of the fuel cell system 10 which also form part of the control subsystem, the system 10 may include valves 69 and 71 that route exhaust that exits the fuel cell stack 20 to a purge exhaust line 77 during purging. More specifically, the valve 69 is connected between the cathode outlet 24 and the purge exhaust line 77, and the valve 71 is connected between the anode outlet 44 and the purge exhaust line 77. During normal operation of the fuel cell stack 20, the valves 69 and 71 are closed to isolate the purge exhaust line 77 from the fuel cell stack 20. However, if the cathode chamber of the fuel cell stack 20 is being purged, the fuel cell system 10 opens the valve 69, and similarly, if the anode chamber of the fuel cell stack 20 is being purged, the fuel cell system 10 opens the valve 71.

As depicted in FIG. 1, the purge exhaust line 77 may also be connected to an inlet of the three-way valve 62. During normal operation of the fuel cell system 10, the valve 62 is configured to block communication between the purge exhaust line 77 and the oxidant inlet of the ATO 70. However, as described further below, it may be desired to purge the ATO 70 after purging of the fuel cell stack 20 is complete. For these embodiments of the invention, the fuel cell system 10 may, subsequent to the purging of the fuel cell stack 20, configure the valve 62 to establish communication between the purge exhaust line 77 and the ATO 70 for purposes of purging the ATO 70.

In other embodiments of the invention, air may be used to purge the ATO 70. In this regard, in this embodiment of the invention, the three-way valve 62 may be configured so that the valve 62 has an inlet connected to the line 35, an outlet connected to the line 77 and an outlet connected to the oxidant inlet of the ATO 70. During the purging of the ATO 70, the controller 110 configures the three-way valve 62 to route air produced by the cathode air blower 30 to the oxidant inlet of the ATO 70 for purposes of purging the ATO 70. Depending on the particular embodiment of the invention, using air to purge the ATO 70 may be particularly advantageous to using an ATO-induced purge flow, as the purging of the ATO 70 lowers the temperature of the ATO 70 and thus, places a time limit regarding the use of the ATO 70 to produce the purge flow. Other variations for purging the ATO 70 and other components of the fuel cell system 10 are contemplated and are within the scope of the appended claims.

The control subsystem for the fuel cell system 10 may also include a controller 110, which communicates via output communication lines 122 with the various components of the fuel cell system 10 for purposes of regulating startup, shutdown and the normal operation of the system 10. For example, the controller 110 is electrically coupled to and controls such components as the cathode 30 and fuel 56 blowers, the reformer 54 and the valves that control normal, shutdown and startup flows in the fuel cell system 10. For example, to purge the anode and cathode chambers of the fuel cell stack 20 with ATO exhaust only, the controller 110 may close the valves 92 and open the valves 94, 100, 104, 69 and 71.

In general, the controller 110 includes a processor 120 which may represent one or more microcontrollers and/or microprocessors, depending on the particular embodiment of the invention. In general, the processor 120 communicates with a memory 112 of the controller 110. The memory 112 may be internal or external to the controller 110, depending on the particular embodiment of the invention. For example, in accordance with some embodiments of the invention, the processor 120 and the memory 112 may be fabricated on the same semiconductor package, may be located on separate semiconductor packages, may communicate via a network and/or may communicate on different processor boards. Thus, many variations are possible and are within the scope of the appended claims.

Regardless, however, of the particular form of the controller 110, the memory 112, in general, stores program instructions 116 that are executed by the processor 120 for purposes of controlling the various aspects of the fuel cell system 10, such as the startup, shutdown and normal operations of the fuel cell system 10 that are disclosed herein. The controller 110 may receive various communications, measured currents, measured voltages, status indications, etc. via input communication lines 124 that are connected to various sensors, measuring circuits, communication interfaces, etc., of the fuel cell system 10.

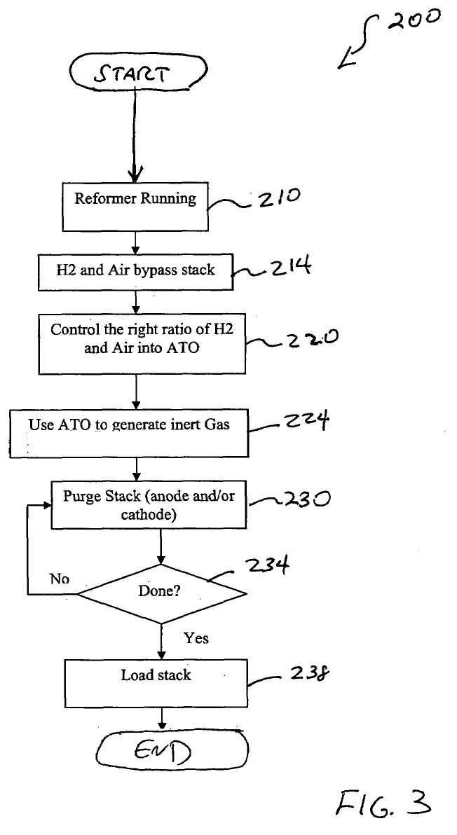

Referring to FIG. 3 in conjunction with FIG. 1, in accordance with some embodiments of the invention, the controller 110 may perform a technique, such as the technique 200, for purposes of starting up and purging the fuel cell stack 20. Pursuant to the technique 200, the controller 110 leaves the reformer 50 running, as depicted in block 210. The controller 110 also controls the three-way valves 34 and 60 for purposes of causing the oxidant and fuel flows, i.e., the reactants, to bypass the fuel cell stack 20. Additionally, the controller 110 controls (block 220) the correct ratio of the fuel and oxidant flows to the ATO 70. In this regard, this control may involve adjusting the three-way valve 34, adjusting the speed of the cathode air blower 30, adjusting the speed of the fuel blower 56 and/or adjusting the position of the three-way valve 60, as examples.

Pursuant to the technique 200, the controller 110 uses (block 224) the ATO 70 to generate an inert gas flow for purposes of purging the fuel cell stack 20. Thus, as described herein, the controller 110 may control the specific mixture or content of the flow that is used to purge the fuel cell stack 20 by operating the valves 90, 92 and 94 to control the ATO exhaust and/or steam mixture that is communicated to the purge line 98.

Once the appropriate valves have been opened and/or closed, the controller 110 opens one or both of the valves 100 and 104 and opens one or both of the valves 69 and 71 to purge the anode chamber, the cathode chamber or both chambers of the fuel cell stack 20, pursuant to block 230. When the controller 110 determines (diamond 234) that the purging of the fuel cell stack 20 is complete, the controller 110 then loads (block 238) the fuel cell stack 20. The controller 110 may determine whether the purging is complete via a number of different techniques, such as using a sensor to determine whether any remaining reactants are flowing from the anode and/or cathode chambers of the fuel cell stack 20, waiting for a predetermined interval of time to elapse, etc. The loading of the fuel cell stack 20 refers to the controller 110 actuating the valves 34 and 60 to allow reactants and oxidants to flow through the anode and cathode of stack 20 to start the electrochemical reaction in stack 20, and furthermore electrically coupling the fuel cell stack 20 to an external load (not depicted in FIG. 1). More specifically, as an example, pursuant to block 238, the controller 110 may operate one or more electrical switches for purposes of electrically connecting the stack 20 to power conditioning circuitry (not shown), which conditions the power into the appropriate form for the load.

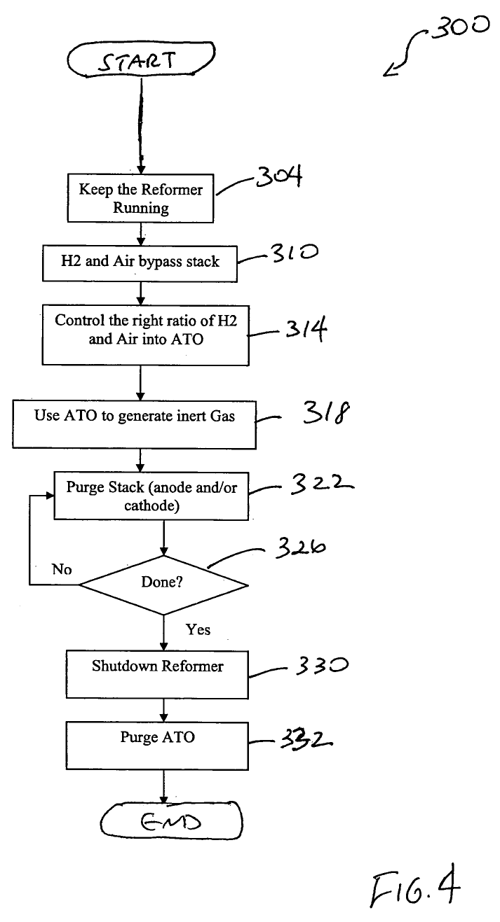

FIG. 4 depicts an exemplary technique 300 that may be used for purposes of shutting down and purging the fuel cell stack 20 and ATO 70 in connection with a shutdown of the fuel cell system 10. Pursuant to the technique 300, the controller 110 keeps the reformer 54 running, pursuant to block 304. Additionally, the controller 110 operates the three-way valves 34 and/or 60 to cause the reactant flow(s) to bypass the fuel cell stack 20, pursuant to block 310. The controller 110 also operates the appropriate components of the fuel cell system 10, as described above in connection with the technique 200, to control the ratio of the oxidant and fuel to the ATO 70, pursuant to block 314.

The controller 110 then uses the ATO 70 to generate the inert gas for the purging, pursuant to block 318. Thus, as described above in connection with the technique 200, the controller 110 operates the valves 90, 92 and 94 in the appropriate manner to control composition of the flow that is communicated to the purge communication line 98.

After the valves of the fuel cell system 10 have been placed in their appropriate states by the controller 110 for purposes of carrying out the purging of the fuel cell stack 20, the purging of the stack begins, pursuant to block 322. The purging continues until the controller 110 determines (diamond 326) that the purging is complete, a determination that may be aided by sensors, measurement of time, etc.

After the purging of the fuel cell stack 20 is complete, the controller 110 shuts down the reformer 54, pursuant to block 330. Next, in accordance with some embodiments of the invention, the controller 110 configures the three-way valve 62 to direct the purge flow through the ATO 70 to purge the ATO 70, pursuant to block 332.

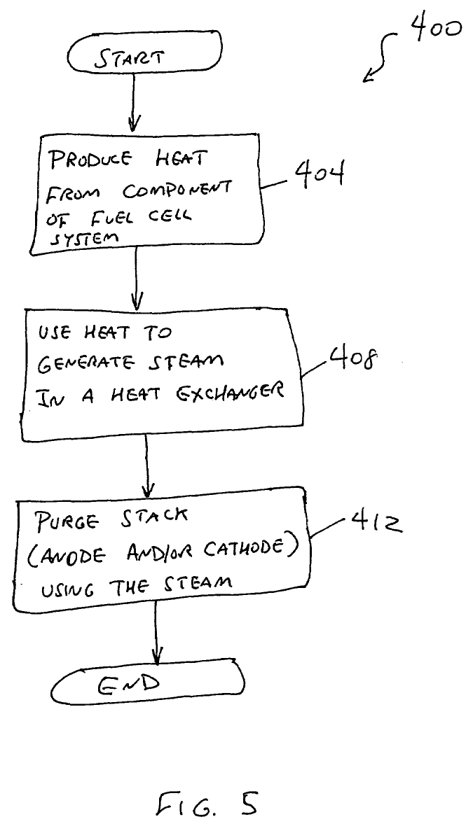

Other embodiments are within the scope of the appended claims. For example, a component of the fuel cell system other than an oxidizer may be used for purposes of generating heat, from which steam is used to purge the stack. More specifically, FIG. 5 depicts a technique 400 that may be used for purposes of purging a fuel cell stack, in accordance with some embodiments of the invention. Pursuant to the technique 400, heat is produced (block 404) from a component of the fuel cell system. As an example, this component may be a component that is operational during the normal mode of operation of the fuel cell system. As specific examples, the component may be an oxidizer, as set forth herein, as well another component, such as a reformer of the fuel cell system, for example. Heat is used (block 404) to generate the steam in a heat exchanger and the stack is then purged (block 412) using the steam. The purging may include purging the anode and/or cathode chambers of the fuel cell stack.

Although PEM fuel cells are disclosed herein, it is understood that the techniques and systems discussed herein may be used with non-PEM fuel cells, in accordance with other embodiments of the invention.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
communicating fuel and oxidant to an oxidizer; and
flowing an exhaust from the oxidizer through a fuel cell to purge the fuel cell.

2. The method of claim 1, wherein the act of flowing the exhaust comprises:
combining the exhaust with steam to form a flow; and
using the flow to purge the fuel cell.

3. The method of claim 1, further comprising:
using the exhaust to generate the steam.

4. The method of claim 1, wherein the act of flowing the exhaust comprises:
lowering a temperature of the exhaust to form a flow; and
using the flow to purge the fuel cell.

5. The method of claim 1, wherein the purging occurs in connection with a startup of a fuel cell system.

6. The method of claim 5, further comprising:
starting up a reformer prior to the purging.

7. The method of claim 5, further comprising:
bypassing the fuel cell with reactant flows prior to the purging.

8. The method of claim 5, further comprising:
connecting an electrical load to the fuel cell system after the purging.

9. The method of claim 1, wherein the purging occurs in connection with a shut down of a fuel cell system.

10. The method of claim 9, further comprising:
shutting down a reformer after the purging.

11. The method of claim 9, further comprising:
purging the oxidizer after the purging of the fuel cell.

12. The method of claim 9, wherein bypassing the fuel cell with reactant flows prior to the purging.

13. A method comprising:
operating a component of a fuel cell system, the operation producing heat;
using the heat to generate a flow to purge a fuel cell in connection with a startup of a fuel cell system.

14. The method of claim 13, wherein the act of operating the component comprises communicating fuel and oxidant to an oxidizer.

15. The method of claim 13, wherein the act of operating comprises:
communicating an exhaust of an oxidizer through the fuel cell.

16. The method of claim 13, wherein the act of operating comprises:
mixing an exhaust of an oxidizer with steam to form the flow.

17. The method of claim 13, wherein the act of using comprises:
using the heat to form steam; and
flowing the steam through the fuel cell.

18. A fuel cell system, comprising:
a fuel cell;
an oxidizer to provide an exhaust; and
a control subsystem to communicate the exhaust through the fuel cell to purge the fuel cell.

19. The fuel cell system of claim 18, wherein the control subsystem combines the exhaust with steam to form a flow and communicates the flow through the fuel cell to purge the fuel cell.

20. The fuel cell system of claim 19, further comprising:
a heat exchanger to generate the steam from the exhaust.

21. The fuel cell system of claim 18, further comprising:
a heat exchanger to lower a temperature of the exhaust before the exhaust is communicated through the fuel cell to purge the fuel cell.

22. A fuel cell system, comprising:
a fuel cell;
a component to generate heat; and
a control subsystem to use the oxidizer to generate a flow to purge the fuel cell in connection with a startup of the fuel cell system.

23. The fuel cell system of claim 22, wherein the component comprises one of an oxidizer and a reformer.

24. The fuel cell system of claim 22, wherein the component comprises an oxidizer and the control subsystem communicates an exhaust of the oxidizer through the fuel cell.

25. The fuel cell system of claim 22, wherein the component comprises an oxidizer and the control subsystem mixes an exhaust of the oxidizer with steam to form the flow.

26. The fuel cell system of claim 22, further comprising:
a heat exchanger to generate steam in response to the heat, wherein
the control subsystem communicates the steam through the fuel cell to purge the fuel cell.
